(19) United States
(12) Patent Application Publication
(10) Pub. No.: US 2024/0405537 A1
(43) Pub. Date: Dec. 5, 2024

(54) Termination for a cable for transporting high-voltage or very-high-voltage electricity, and method for preparing a cable end termination

(71) Applicant: NEXANS, Courbevoie (FR)

(72) Inventors: Francois SESSOUC, CALAIS (FR); David DUBOIS, COURBEVOIE (FR); Quentin EYSSAUTIER, Hafslundsøy (NO); Jean-Francois BRAME, Coulogne (FR); Emeric HENAUT, COURBEVOIE (FR); Matthieu OUSSELIN, CALAIS (FR)

(21) Appl. No.: 18/723,797

(22) PCT Filed: Dec. 16, 2022
(86) PCT No.: PCT/FR2022/052398

§ 371 Date: Jun. 24, 2024

(30) Foreign Application Priority Data
Dec. 23, 2021 (FR) 2114447

(51) Int. Cl. H02G 15/064; H02G 1/12

(52) U.S. Cl. CPC H02G 15/064; H02G 1/1236; H02G 1/127

(57) ABSTRACT

Termination for a cable for transporting high-voltage or very-high-voltage electricity, comprising a composite end (8) of a cable (1) comprising a free end of a cable, the cable comprising an elongate central conducting element (2) and a plurality of layers arranged successively from the innermost to the outermost coaxially around this conducting element, this plurality of layers comprising an inner semi-conducting layer (3), an electrically insulating layer (4), an outer semi-conducting layer (5), such that part of the layers is stripped starting from a distal end of the free end of the cable, the outer semi-conducting layer (5) being stripped over an axial length greater than the length over which the electrically insulating layer (4) is stripped, such that one end of the outer semi-conducting layer (5) forms a chamfer (14), the cable termination comprising a stress cone (20) provided with an annular lip (22), such that this cone lip (22) covers the chamfer (14) over the entirety of its length.

The present invention relates to a termination for a cable for transporting high-voltage or very-high-voltage electricity for a composite high-voltage or very-high-voltage cable end, notably composite ends which are introduced into these electrical terminations so that they can be connected to a connector. Another subject of the invention is a method for preparing a high-voltage or very-high-voltage cable end. In particular, the invention finds an application when combined with a flameproof terminal arranged on the outside around this termination of such a high-voltage cable.

As described in patent documents EP 2 259 401 and DE 2 746 566, it is known practice for a cable termination to comprise a cable end, this end is coupled to a connector inside a pressuretight terminal, the pressuretight terminal forming a flameproof terminal and comprising a cylindrical sleeve, a lower plate and an upper plate, the plates closing off the sleeves at its two respective opposite ends in order to define a pressuretight volume able to contain an insulator. Together, the composite end of the cable and the connector define the cable termination.

In order to allow connection between the connector and the composite end of the high-voltage cable in such a terminal, it is known practice, notably from patent documents EP 2 461 448 and FR 3 009 901, to position a stress cone, made of a flexible material, around a central conductor of the composite end of the cable. Such a stress cone is of relatively limited length and volume.

The invention applies to the fields of high-voltage (notably higher than 60 kV, and potentially as high as 800 kV) power cables for either direct or alternating current. Power cables typically comprise a central electric conductor and at least one electrically insulating layer made from a cross-linked or thermoplastic material using techniques well known to those skilled in the art.

Because the electrical terminations are generally placed inside fireproof terminals standing vertically on the ground, there is a need to improve the tensile strength of the cable ends held in connectors inside these terminals, including for service temperatures of over 100° C., for example of the order of 130° C. There are also shorter electrical terminations used in cable terminations for gas insulated switchgear (GIS). These terminations represent solutions that are not as bulky as the conventional air-insulated terminations. For these GIS terminations there is a need to improve the pressuretight sealing of the termination and the integrity of the electrical-contact made at the termination. Terminations of GIS type in particular constitute an advantageous component in a high-voltage DC connection because of the flexibility and the reduction in volume that they afford to the cable connections, particularly in cramped spaces such as offshore platforms.

To this end, the invention relates to a termination for a cable for transporting high-voltage or very-high-voltage electricity, for a composite end of a cable for transporting high-voltage or very-high-voltage electricity comprising a free end of a cable, the cable comprising an elongate central conducting element and a plurality of layers arranged successively from the innermost to the outermost coaxially around this conducting element, this plurality of layers comprising an inner semi-conducting layer, an electrically insulating layer, an outer semi-conducting layer, such that part of the layers is stripped starting from a distal end of the free end of the cable, the outer semi-conducting layer being stripped over an axial length greater than the length over which the electrically insulating layer is stripped, and one end of the outer semi-conducting layer forming a chamfer.

Moreover, the termination for a cable for transporting high-voltage or very-high-voltage electricity comprises a stress cone provided with an annular lip, the cone lip being positioned around a chamfer so that a free edge of this lip presses against the chamfer. The collaboration between the annular lip and this low-gradient chamfer, the annular lip preferably having a cylindrical interior periphery, enables the creation of an annular seal over an axial length that is sufficient to withstand the temperature and pressure variations commonly encountered in such a termination.

As a preference, the chamfer may have a gradient of less than 2°. In particular, because the outer semi-conducting layer is annular, it may be defined by a radial thickness of between 1 and 2 mm. More particularly, one edge of the chamfer, the one in contact with the electrically insulating layer, may be defined in an annular zone measuring less than 5 mm in axial length along a longitudinal axis of the cable, so as to improve the area of contact with an annular lip of a stress cone.

In particular, the outer semi-conducting layer may be made from a thermoplastic material and, more particularly still, may have a hardness below a predetermined threshold notably, in the case of a Shore A hardness, below 95 and, in the case of a Shore D hardness, below 43.

Another subject of the invention is a method for preparing a termination end of a cable for transporting high-voltage or very-high-voltage electricity according to the invention, in which method the preparation steps, notably for stripping the cable, comprise the following steps:
stripping the electrically insulating layer starting from a distal end of a free end of the cable using a stripper device so that the outer semi-conducting layer is removed over an axial length that is greater than the length over which the electrically insulating layer is stripped,
using a glass blade to modify a gradient of the end of the outer semi-conducting layer in order to form a chamfer,
adding a stress cone provided with an annular lip around this free end so that this cone lip covers the chamfer over the entirety of its length.

More particularly, and with regard to the mechanical characteristics of the outer semi-conducting layer, the method may employ a stripper device comprising a flat blade oriented perpendicular to a longitudinal axis of the cable.

### BRIEF DESCRIPTION OF THE DRAWINGS

The appended drawings illustrate the invention:

FIG. 1 depicts a power cable according to the invention, shown in an exploded view the better to identify the main layers of which it is composed;

FIG. 2 depicts a detailed view of a termination according to the invention, employing a composite end of a cable according to the invention in collaboration with a stress cone;

FIG. 3 depicts a view of detail A of FIG. 2;

FIG. 4 and FIG. 5 depict a perspective view of a stripper device used in the method according to the invention;

FIG. 6 depicts a schematic overview showing the blade of the stripper device relative to the end of the cable in a method according to the invention; and

FIG. 7 depicts the chamfering step of the method according to the invention in which the outer semi-conducting layer is chamfered using a glass blade.

### DESCRIPTION OF EMBODIMENT(S)

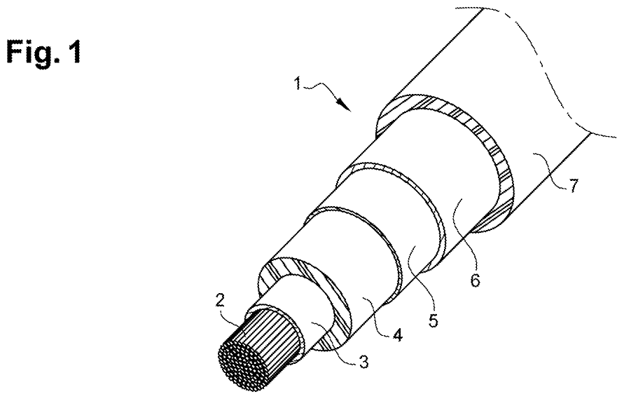

A high-voltage power cable 1, illustrated in FIG. 1, comprises an elongate central conducting element 2, notably made of copper or of aluminium. The power cable 1 also comprises several layers arranged successively and coaxially around this conducting element 2, these being considered successively from the innermost to the outermost, and namely being: a first semi-conducting layer 3 known as the “inner semi-conducting layer”, an electrically insulating layer 4, a second semi-conducting layer 5 known as the “outer semi-conducting layer”, an earthing and/or protective metal screen/shield 6, and a protective outer sheath 7. The presence of the metal screen/shield 6 and of the outer protective sheath 7 is preferential, but not essential, this cable structure being well known per se to those skilled in the art.

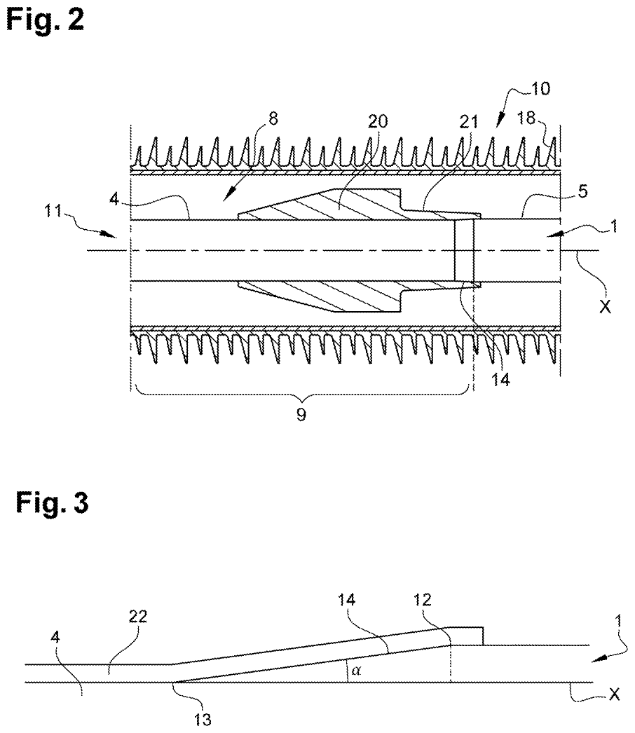

The end 8 of this cable is intended to be connected to a connector (not depicted) so as to form a termination, notably inside a fireproof terminal 10, the cylindrical sleeve 18 of which terminal is depicted in FIG. 2. This end 8 extends over a portion 9 of the cable 1 extending between its free end 11 and a non-stripped edge 12 of the outer semi-conducting layer 5. The cable 1 is surrounded by a stress cone 20. This cone 20 comprises a body 21 mounted around the insulating layer 4, this body comprising an annular lip 22 extending over part of the portion 9 of the cable. More particularly, this annular lip 22 extends in part around a free end 13 of the outer semi-conducting layer 5. As a preference, the annular lip 22 extends around the outer semi-conducting layer 5, beyond the non-stripped edge 12.

The lip 22 is made from a flexible material capable of deforming radially around the cable 1 so as to create an annular seal around the outer semi-conducting layer 5.

In a termination of the GIS type, the cylindrical sleeve 18 is replaced by an epoxy-containing insulating sleeve. This insulating sleeve has a smooth exterior periphery.

As depicted in FIG. 3, the outer semi-conducting layer 5 has a chamfer 14 between its free end 13 and a non-stripped edge 12 of this layer 5. Thus, the annular lip can cover the chamfer 14 over the entirety of its length.

The free end 13 forms an edge of the chamfer 14. The chamfer 14 defines a frustoconical surface. In particular, the gradient a of this chamfer is less than 10°, preferably less than 2°, for example of the order of 1.6°. This gradient a extends over an axial length of the order of 10 cm along the longitudinal axis of the cable. In particular, the chamfer edge 13 defines an annulus extending substantially in a plane orthogonal to the longitudinal axis. Thanks to the preparation method according to the invention, the chamfer edge 13 extends in an annular zone of a length l measuring less than 10 mm, preferably less than 5 mm.

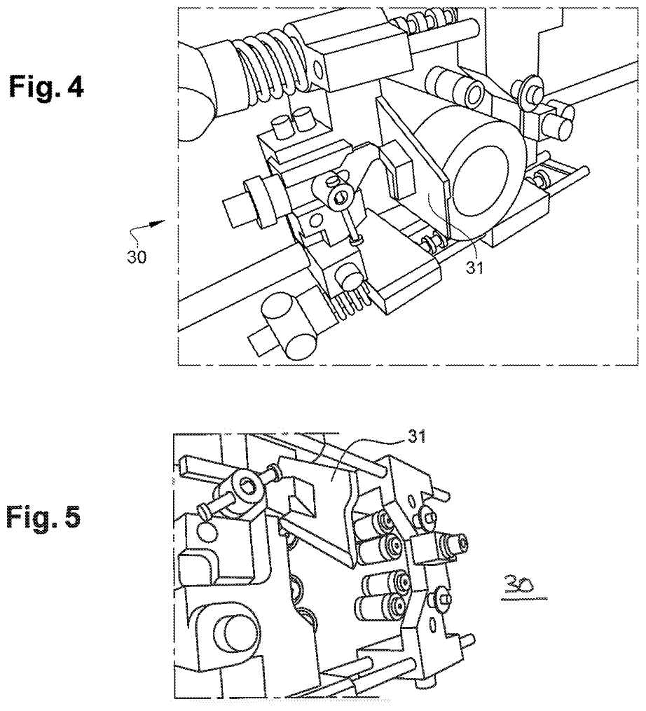

FIG. 4 depicts a stripper device 30, in which a blade 31 is driven in a helicoidal movement around the cable. In particular, according to the invention, stripping commences from the free end 11 of the cable and extends as far as the free end 13 of the outer semiconductor layer 5.

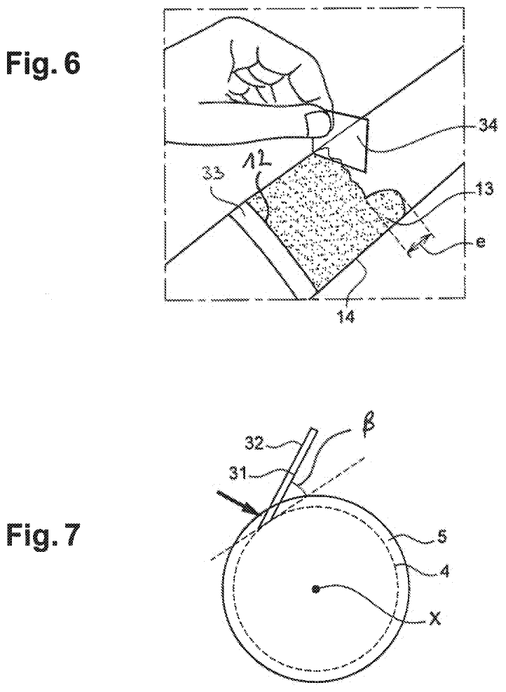

As depicted in FIGS. 4 and 6, the blade 31 defines a cutting edge 32 substantially in the plane orthogonal to the longitudinal axis X. Along the axis X, the blade 31 is also in a plane that forms a small angle β with the tangent to the stripped outer periphery of the insulating layer 4. One edge of this blade 31 remains in contact with the insulating layer 4 as it moves in a helix around the cable.

In order to prepare the end of the cable, material of the outer semi-conducting layer 5 is removed by stripping as far as the free end 13.

Thereafter, in order to finalise the preparation of the free end of the cable, according to the radial thickness of the outer semi-conducting layer 5 and to the angle α desired for the chamfer 14, an operator tasked with the preparation arranges a circumferential guide mark 33 around the outer semi-conducting layer 5 in order to delimit the zone that is to be chamfered.

In order to modify the gradient of the end of the outer semi-conducting layer 5 in order to chamfer the zone determined beforehand and in order to modify the surface condition in order to make this as smooth as possible, the operator uses a glass blade 34 and performs longitudinal back and forth movements which are repeated on all the angular sectors of the zone that is to be chamfered. The chamfering is performed manually so that the gradient varies by only + or −0.2° between the chamfer edge 13 and the non-stripped edge 12.

1. A termination for a cable for transporting high-voltage or very-high-voltage electricity, comprising:
a composite end of a cable for transporting high-voltage or very-high-voltage electricity has a free end of a cable, the cable having an elongate central conducting element and a plurality of layers arranged successively from the innermost to the outermost coaxially around this conducting element, this plurality of layers having an inner semi-conducting layer, an electrically insulating layer, an outer semi-conducting layer, such that part of the layers is stripped starting from a distal end of the free end of the cable, the outer semi-conducting layer being stripped over an axial length greater than the length over which the electrically insulating layer is stripped,
wherein one end of the outer semi-conducting layer forms a chamfer,
wherein said termination has a stress cone provided with an annular lip, such that this cone lip covers the chamfer over the entirety of its length.

2. The termination according to claim 1, wherein the chamfer has a gradient of less than 2°.

3. The termination according to claim 1, wherein one chamfer edge, in contact with the electrically insulating layer, is defined in an annular zone of axial length measuring less than 5 mm along a longitudinal axis of the cable.

4. The termination according to claim 1, wherein the outer semi-conducting layer is made from a thermoplastics material.

5. The termination according to claim 1, wherein the outer semi-conducting layer has a hardness below a predetermined threshold, in the case of a Shore A hardness, below 95 and, in the case of a Shore D hardness, below 43.

6. A method for preparing a termination for a cable for transporting high-voltage or very-high-voltage electricity for an end of a cable for transporting high-voltage or very-high-voltage electricity, having a free end of a cable, the cable having an elongate central conducting element and a plurality of layers arranged successively from the innermost to the outermost coaxially around this conducting element, this plurality of layers having an inner semi-conducting layer, an electrically insulating layer, and an outer semi-conducting layer,
wherein said method comprises the steps of:
stripping the electrically insulating layer starting from a distal end of a free end of the cable using a stripper device so that the outer semi-conducting layer is removed over an axial length that is greater than the length over which the electrically insulating layer is stripped,
using a glass blade to modify a gradient of the end of the outer semi-conducting layer in order to form a chamfer thereon, and
adding a stress cone provided with an annular lip around this free end so that this cone lip covers the chamfer over the entirety of its length.

7. The method according to claim 6, wherein the stripper device comprises a flat blade oriented perpendicular to a longitudinal axis of the cable.
